(19) United States
(12) Patent Application Publication
(10) Pub. No.: US 2014/0001721 A1
(43) Pub. Date: Jan. 2, 2014

(54) ERGONOMIC CART

(71) Applicant: John C. Benko, Westlake, OH (US)

(72) Inventor: John C. Benko, Westlake, OH (US)

(21) Appl. No.: 13/536,096

(22) Filed: Jun. 28, 2012

(51) Int. Cl. B62B 1/00

(52) U.S. Cl. 280/47.28

(57) ABSTRACT

A transfer cart primarily designed for the beverage distribution industry permits the operator or driver to work at waist level when loading or unloading. The cart includes a lift plate mounted on a vertically movable carriage with a parallel pair of gas springs urging the plate to an elevated position so that the lift plate lowers or rises as weight is added or removed, respectively. The angle of the plate may be adjusted and folds out of the way when not in use to be held with a magnetic latch. The cart is designed for ergonomic transportation of both cases and kegs.

This invention relates generally as indicated to an ergonomic cart and more particularly to a cart which helps the user avoid a series of deep back bends when loading or unloading the cart. The cart is particularly designed for the beverage industry and can accommodate cases or kegs.

### BACKGROUND OF THE INVENTION

Back injuries are often sustained when someone has to pick up or place a relatively heavy object either from, or on the floor. This is particularly so if the lifting or placing has to be done repeatedly.

Many such objects or items are transferred from a truck, for example, to a customer, or sometimes to or from a warehouse. A two wheeled dolly or cart known as a hand truck is often used for such purposes. For example, a beverage distributor will remove cases or kegs from a truck and place or stack them one at a time on the projecting shelf at the bottom of the cart and build a stack on the cart. When the cart is full the stack is tilted back and wheeled into a customer's business, for example, usually to be stacked again in a storage area. The case at the top of the stack is the easiest to place or transfer because it can be removed or placed without bending over.

It would accordingly be desirable particularly in the beverage industry if a cart or dolly could be provided where the stack on the cart or dolly is formed on or removed from the cart without bending over. It would also be desirable if heavy kegs could be transported without heavy lifting from or placement on the floor.

### SUMMARY OF THE INVENTION

A transfer cart primarily designed for the beverage distribution industry permits the operator or driver to work at waist level when loading or unloading. The cart includes a lift plate mounted on a vertically movable carriage with a parallel pair of gas springs urging the plate to an elevated position so that the lift plate lowers or rises as weight is added or removed, respectively. The angle of the plate may be adjusted and folds out of the way when not in use, and is held folded with a magnetic latch.

The present invention has wide utility in the transfer of stackable items. A few of the examples are cardboard boxes used by movers, or for the storage or shipment of files, beverage cases or kegs, or bottles of water, luggage, sacks of cement, feed, or anything else stackable as discrete loads. It has particular utility as a beverage distribution cart for transportation of both cases and kegs.

To the accomplishment of the foregoing and related ends the invention, then, comprises the features hereinafter fully described and particularly pointed out in the claims, the following description and the annexed drawings setting forth in detail certain illustrative embodiments of the invention, these being indicative, however, of but a few of the various ways in which the principles of the invention may be employed.

### BRIEF DESCRIPTION OF THE DRAWINGS

FIG. 1 is a perspective view of the cart of the invention accommodating a keg;

FIG. 2 is a similar view of the cart without the keg;

FIG. 3 is a front elevation of the cart;

FIG. 4 is a side elevation of the cart;

FIG. 5 is a side elevation of the vertically movable carriage and the parallel gas springs;

FIG. 6 is an elevation of the carriage and springs as seen from the right hand side of FIG. 5; and;

FIG. 7 is an enlarged top view of the cart.

### DETAILED DESCRIPTION OF THE PREFERRED EMBODIMENT

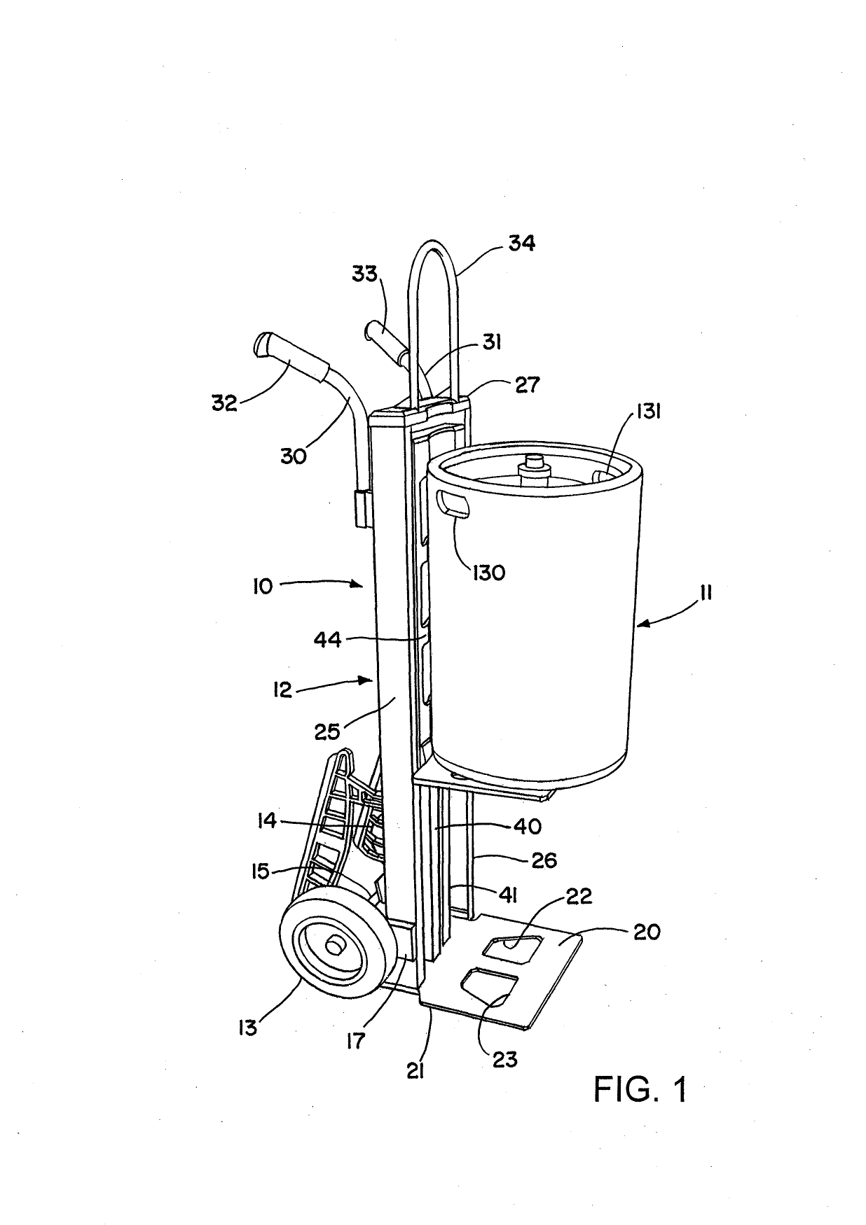

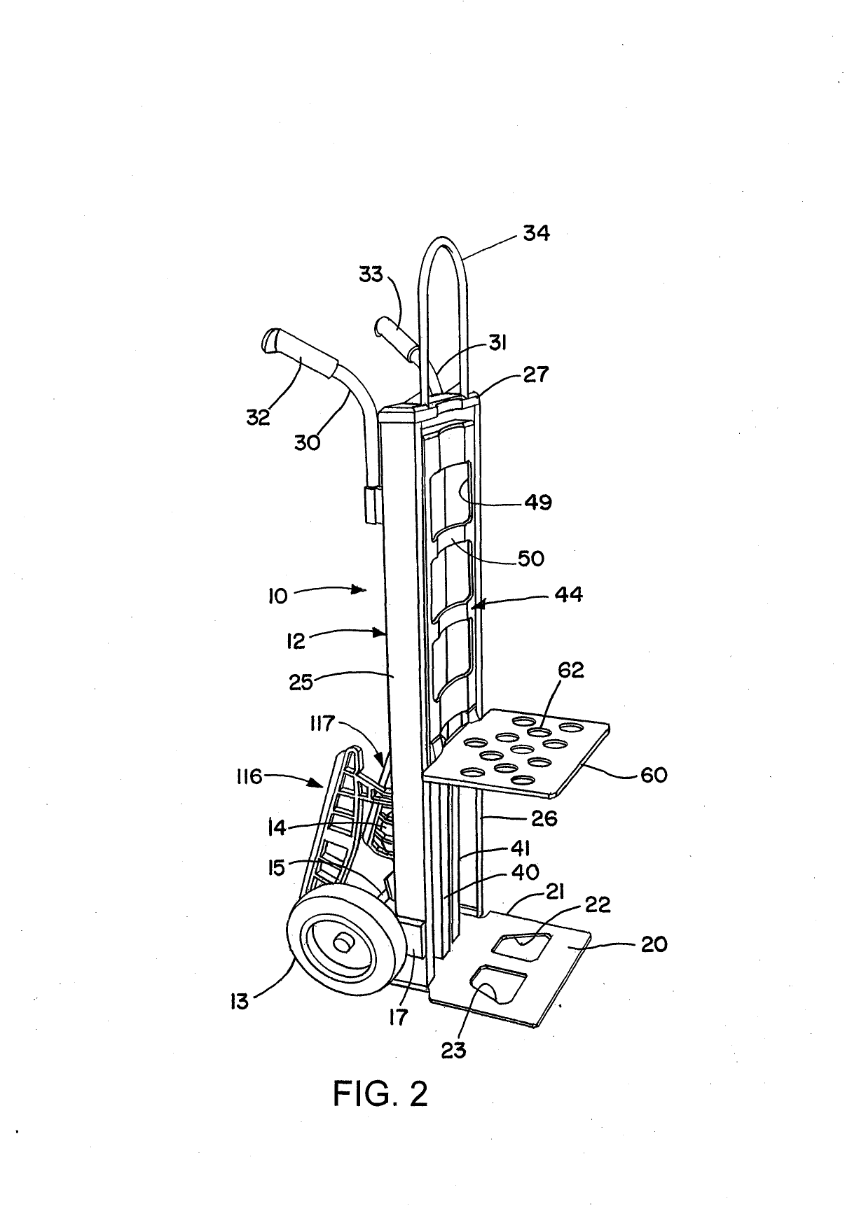

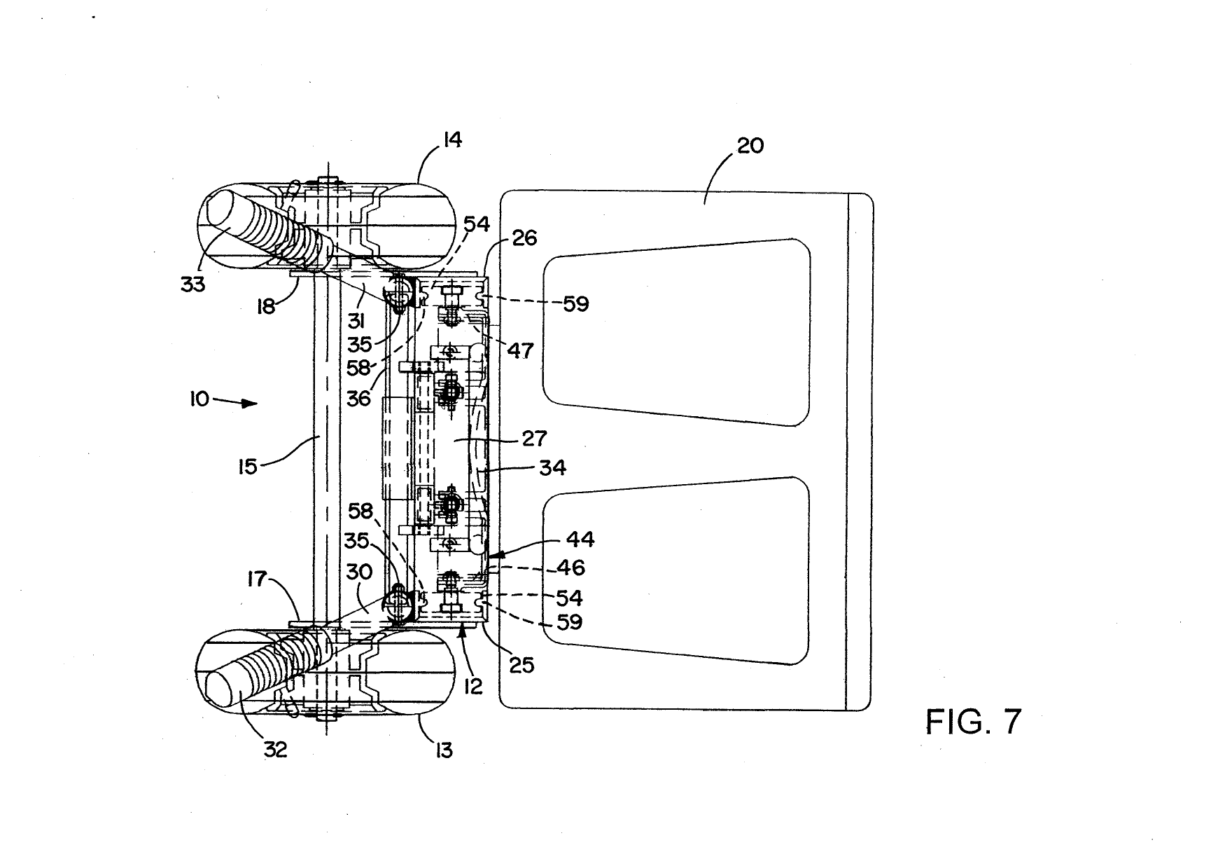

Referring initially to FIGS. 1 and 2, there is illustrated an ergonomic cart shown generally at 10 in accordance with the present invention. FIGS. 1 and 2 are identical except for the presence of the accommodated beverage keg 11 in FIG. 1 and its absence in FIG. 2. The cart includes an upright frame 12 supported at the bottom by wheels 13 and 14 on the ends of axle 15. The axle is in turn supported by rearwardly extending plates 17 and 18 at the bottom of the frame 12, both of which are seen more clearly in FIG. 7.

The bottom of the frame is provided with a generally horizontal plate 20 which is wider than and projects forwardly of the frame as seen at 21. Such projection plate may be provided with weight reducing openings 22 and 23. The plate is fixed with respect to the frame and enables the cart to stand up-right unsupported as shown. This plate as well as other components of the cart may be formed for example of an aluminum-magnesium alloy to provide a rugged light weight construction.

The frame 12 extends upwardly from the plate almost perpendicular and includes two parallel channel-shape side frames 25 and 26 connected at the top by top frame member 27. Handles 30 and 31 are secured to the back of the frame and the respective grips 32 and 33 splay outwardly slightly as seen more clearly in FIG. 7. The top of the frame may be provided with an optional inverted U-shape extension 34 as seen to facilitate the handling of the cart. The handles 30 and 31 are secured by fasteners 35 to a bracket 36 secured to frame 12 as seen more clearly in FIG. 7.

The main frame also includes two spaced but parallel vertical bars 40 and 41 which extend the full height of the frame 12 from the bottom plate 20 to the top frame number 27. The bars are at the back of the frame and rigidify the frame as well enclose the back of the frame protecting and further guiding the vertically removable carriage frame assembly 44.

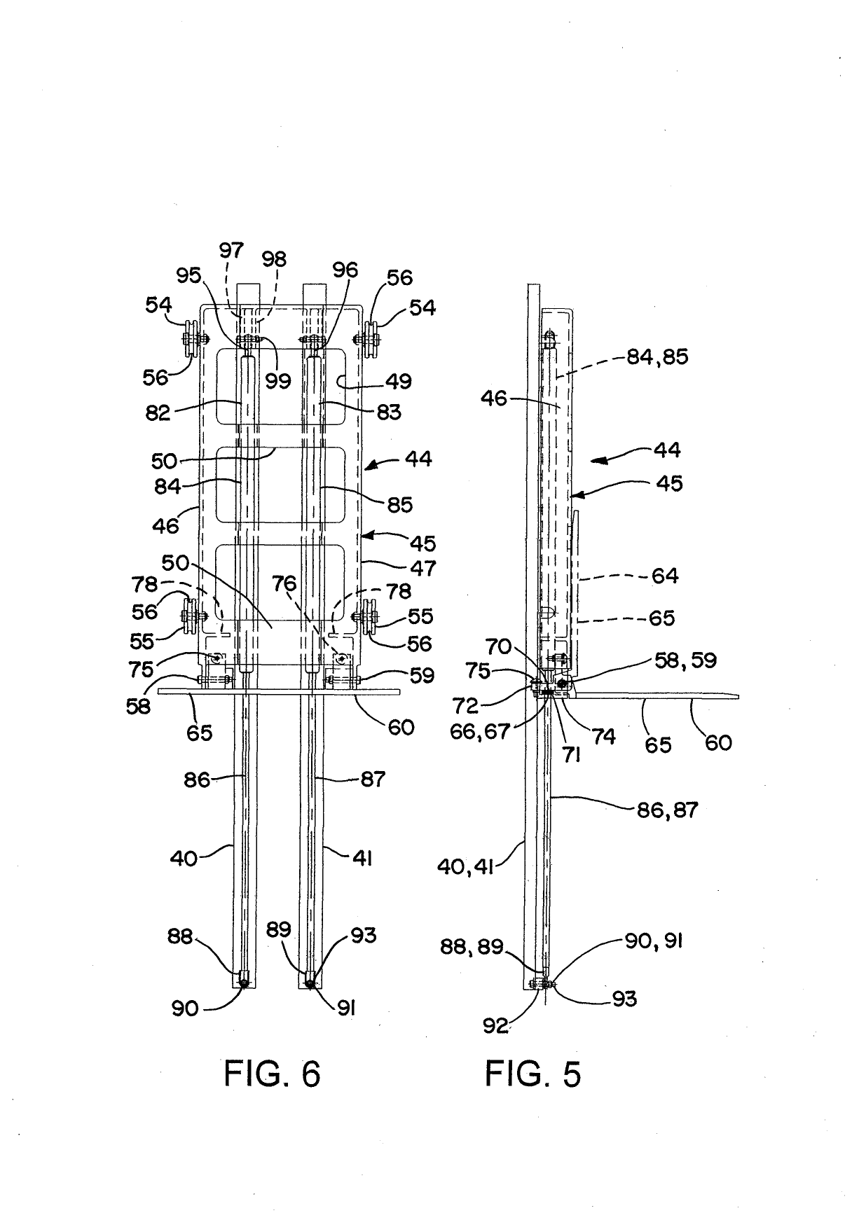

Referring now to the other Figures and more particularly to FIGS. 5 and 6 it will be seen that the carriage assembly 44 itself includes a frame 45 which is formed of wide channel shapes having parallel vertical edge flanges 46 and 47. The front 48 of the carriage frame is provided with major rectangular openings seen at 49 and the horizontal spans between, above and below such openings are bent or dished rearwardly as seen at 50 to provide a nest or recess for a keg as seen in FIGS. 1 and 2.

Projecting outwardly from both the edge flanges 46 and 47 are top and bottom guide rollers 54 and 55. All four rollers are provided with a center groove 56 which ride on facing rail projections 58 and 59 on the inside of each of the channel-shape vertical edges of the main frame. This relationship is most clearly seen in enlarged FIG. 7. The rollers are simply journaled idler rollers mounted on and projecting from the carriage frame edge flanges.

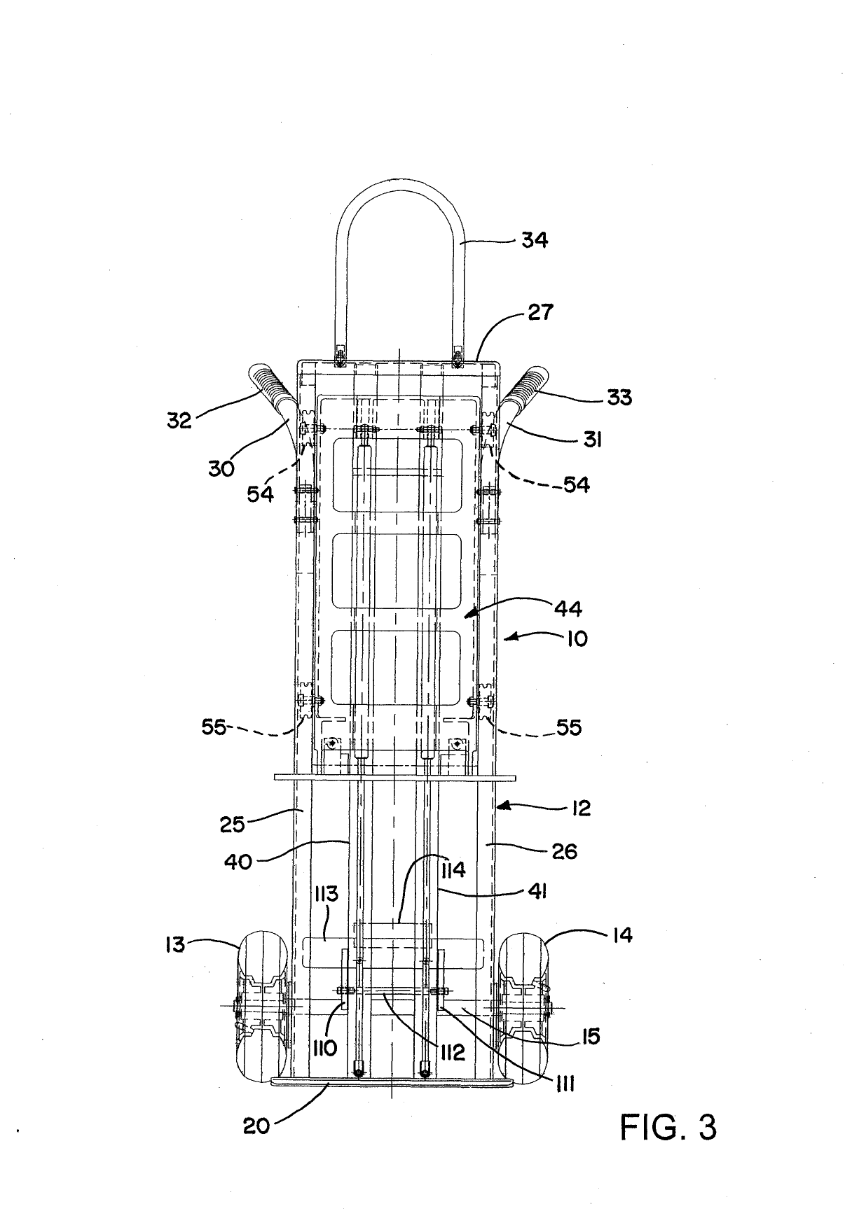

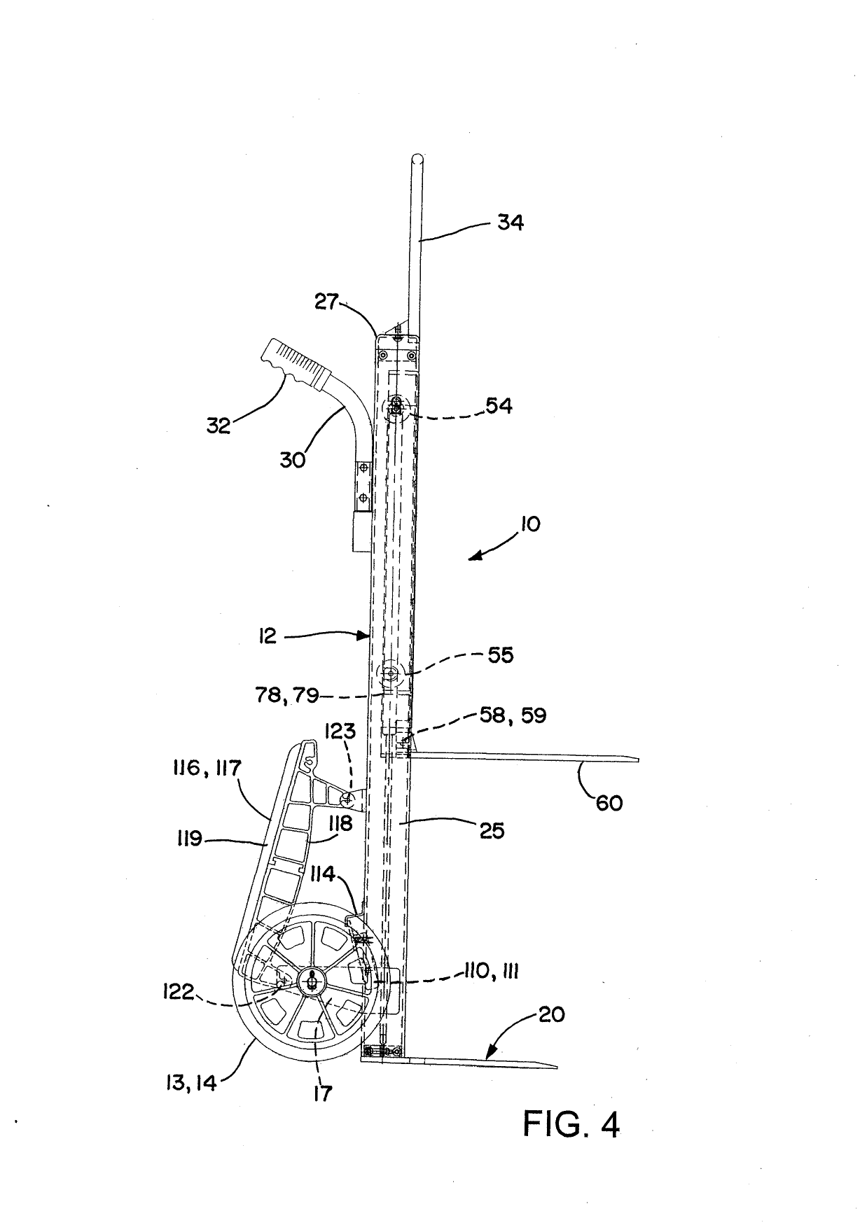

Pivoted to the bottom of the carriage at 58 and 59 is a lift plate 60 as seen in FIGS. 4 and 5. The lift plate 60 is approximately the size of the plate 20 and has a series of holes 62 for weight reduction as seen more clearly in FIG. 3. It is noted that the plate-carriage pivot 58, 59 is offset both from the plane of the plate and the front of the carriage. This enables the plate to be pivoted upwardly to the phantom line position 64 seen in FIG. 5 flush with the front of the carriage and with no portion of the plate projecting horizontally beyond the bottom 65 of the plate.

The plate is latched in its upright out-of-the-way position 64 by sets of magnetic latches 66 and 67, one set at each side at the plate hinge. The latches are in the form of paired magnetic buttons 70 and 71, one on the bottom of the arm at 72 and the other on the inside of top surface of carriage bottom flange brackets 74. The very end of each arm 72 is provided with an adjustable semi-spherical button as seen at 75 and 76. When the plate is in its down or horizontal position the buttons engage the back of the bottom of the carriage frame as seen more clearly in FIG. 5. The carriage frame may be beefed up at the pivots near the bottom by, for example, increased thickness and stiffening flanges seen at 78 and 79, respectively. Again, other than the magnetic buttons the preferred material for construction is the aluminum-magnesium alloy providing ruggedness and yet light weight. It is noted that the magnetic latches will keep the plate in the upright phantom line position 64 when not in use, such as stored on a beverage truck. However, when the operator wants to use the truck, grabbing the top edge of the plate and pulling away from the frame provides more than enough leverage arm easily to open the latches.

With continuing principal reference to FIGS. 5 and 6 it will be seen that the main frame and carriage frame are inter-connected by a pair of long-stroke parallel gas shocks or springs seen at 82 and 83, each comprising a piston-cylinder assembly. The cylinders of such assemblies are shown at 84 and 85, respectively, and the projecting rods at 86 and 87.

The rod ends seen at 88 and 89 respectively are connected at 90 and 91 to the bottom of main frame vertical parallel bars 40 and 41. Each rod is provided with a flattened tip and is secured to a spacer block 92 by the fasteners shown at 93. This maintains the parallelism of the bar and rod.

The blind end of each cylinder includes a projection seen at 95 and 96 fastened between clevis-like flanges 97 and 98 at the top of the carriage frame by the fasteners 99. The gas springs or shocks are thus connected between the main frame and carriage frame and bias the latter upwardly.

The stroke of the gas springs is on the order of about 20 inches or more and is designed to position the lift plate 60 in its elevated position approximately aligned with the bed of a beverage truck. This is also at about the waist level of the operator. This enables kegs or cases to be placed on the carriage plate without bending over.

Since the gas springs normally bias the lift plate 60 to an up or elevated position when empty there may be occasions when the operator wants the plate in the down position and to keep it there. For this reason, the cart is provided with two pivot latches or dogs 110 and 111 fixed to and connected by pivot rod 112 pivotally mounted on the lower end of the frame as seen in FIG. 3. At the top the latches are connected by a kick-plate 113 confined at the top by angle bracket 114. The bracket limits counter-clockwise movement of the latches and kick-plate but permits limited clockwise movement to release the latches when the plate is kicked. The latches or dogs are designed to engage the tops of flanges 78 and 79 seen in FIG. 3. With the latches above the flanges the carriage and plate will be held in its down position until the operator releases the latches with the kick-plate 113.

Also as seen in FIGS. 1, 2 and 4 the cart may be provided with stair glides 116 and 117 at each side. Each stair glide includes a frame 118 with a slide wear bar 119 such as certain wear resistant yet high lubricity plastics. The wear bars are positioned substantially tangent to the wheels. The stair glides may be removably secured to the back of the cart as indicated at 122 and 123.

It can now be seen that there is provided a simplified ergonomic cart which is particularly suitable for the beverage industry. The cart includes a plate which automatically raises or lowers as weight is removed or added, respectively. For example, as the operator places cases on the plate the plate lowers. The operator then can build a stack on the cart working only at waist height. As the operator removes cases from the stack the plate rises and thus the stack, so the operator is continually removing cases from the stack at waist height.

Kegs can easily be placed on the plate when elevated and the weight of the full keg will cause the plate and keg to descend but still placing the upper handles 130 and 131 of the keg seen in FIG. 1 at approximate waist height. A loaded keg can easily be removed from the down plate or if needed to be elevated, the gas springs will do most of the work or heavy lifting. Although useful in other application the cart is particularly beneficial for the beverage industry.

Although the invention has been shown and described with respect to certain preferred embodiments, it is obvious that equivalent alterations and modifications will occur to others skilled in the art upon the reading and understanding of this specification. The present invention includes all such equivalent alterations and modifications, and is limited only by the scope of the claims.

1. A cart comprising an upright frame supported on wheels with a handle on top, a vertically movable carriage in said frame, said carriage including a projecting load supporting plate, said carriage and plate being movable from an up substantially operator waist height position and a down position, and vice versa, a pair of long stroke gas springs connecting said carriage and said movable up-right frame and biasing said carriage and plate to said up position; and said gas springs being means responsive to placing a weighted object on said plate when in the up position to cause said plate and carriage to descend from the waist height position, the extent of descent depending on the weight of the object, whereby the operator may build a stack of objects on the cart without bending from waist height, and said gas springs further being means responsive to the removal of the top object on the stack to elevates the carriage and plate and thus the stack whereby the operator may remove objects from the stack without deep bending from waist height.

2. A cart as set forth in claim 1 wherein the up position of the carriage and plate is at the appropriate height of the bed of a beverage truck when the cart is on the ground.

3. A cart as set forth in claim 2 wherein the carriage includes a concave front surface to accommodate an upright beverage keg on said plate.

4. A cart as set forth in claim 1 wherein said upright frame includes a top frame and a bottom plate, and parallel bars extending from the bottom plate to the top frame, said gas springs being connected from the bottom of the bars to the top of the carriage.

5. A cart as set forth in claim 4 wherein said gas springs are two in number and are aligned with and parallel to said bars, respectively.

6. A cart as set forth in claim 5 including rollers on said movable carriage, and a guide track on said upright frame confining and guiding the movement of the movable carriage with respect to the upright frame.

7. A cart as set forth in claim 1 including an offset pivot connection between said load supporting plate and said carriage whereby said load supporting plate may be folded up to be flush against the front of the carriage.

8. A cart as set forth in claim 7 including a magnetic latch to hold the load supporting plate in the folded-up position.

9. A cart as set forth in claim 8 including an offset arm on said plate, and a stop button on said arm operative to engage said carriage to position said plate in a generally horizontal object receiving position.

10. A cart as set forth in claim 9 wherein said arm extends at substantially right angles to said plate, and one part of said magnetic latch being on the bottom of said arm when the plate is in the folded-up position.
